(19) United States
(12) Patent Application Publication
(10) Pub. No.: US 2026/0304315 A1
(43) Pub. Date: Oct. 1, 2026

(54) ACCESS POINT CONFIGURED FOR UNAVAILABILITY ADVERTISEMENT WITH TARGET WAKE-UP TIME (TWT)

(71) Applicant: Intel Corporation, SantaClara, CA (US)

(72) Inventors: Daniel F. Bravo, Portland, OR (US); Laurent Cariou, Milizac (FR); Carlos Cordeiro, Portland, OR (US); Emily H. Qi, Gig Harb, WA (US)

(21) Appl. No.: 19/478,670

(22) PCT Filed: Jun. 14, 2024
(86) PCT No.: PCT/US2024/034166

§ 371 Date: Oct. 24, 2025

Related U.S. Application Data
(60) Provisional application No. 63/509,497, filed on Jun. 21, 2023.

(51) Int. Cl. H04W 52/02; H04W 68/02; H04W 84/12

(52) U.S. Cl. CPC H04W 52/0216; H04W 52/0206; H04W 68/02; H04W 84/12

(57) ABSTRACT

An access point (AP) operating as a Target Wake-up Time (TWT) scheduling AP may encode a broadcast TWT element for transmission to advertise a broadcast TWT with one or more broadcast TWT Service Periods (SPs). When the broadcast TWT element carries one or more broadcast TWT parameter set fields with a broadcast TWT ID subfield equal to zero and has a Responder Power Management (PM) Mode subfield equal to one, the AP may set a NDP Paging Indicator/Unavailability Mode subfield of a Control Field of the broadcast TWT element to a value of zero to indicate that the AP is unavailable outside of the one or more broadcast TWT SPs except for other TWT SPs that are setup with the AP or advertised by the AP. The AP may set the NDP Paging Indicator/Unavailability Mode subfield of the Control field to a value of one to indicate that the AP is unavailable outside of the one or more broadcast TWT SPs including unavailable during any time that falls within the other TWT SPs that are setup with the AP or advertised by the AP.

### PRIORITY CLAIM

This application claims the benefit of priority to United States Provisional Patent Application Ser. No. 63/509,497, filed Jun. 21, 2023, [reference number AF4234-Z] which is incorporated herein by reference in its entirety.

### TECHNICAL FIELD

Embodiments pertain to wireless local area networks (WLANs) in accordance with an IEEE 802.11 standard.

### BACKGROUND

The management of power consumption in wireless communication systems, particularly in Wi-Fi networks, particularly, maintaining efficient power usage while ensuring consistent connectivity and data transmission is a challenge. This is addressed through various mechanisms that manage the activity and inactivity periods of devices connected to the network, allowing them to enter low-power states when not actively transmitting or receiving data. The coordination of these periods is crucial for optimizing network performance and reducing power consumption without compromising the quality of service.

### BRIEF DESCRIPTION OF THE DRAWINGS

FIG. 1 is a block diagram of a radio architecture in accordance with some embodiments.

FIG. 2 illustrates a front-end module circuitry for use in the radio architecture of FIG. 1 in accordance with some embodiments.

FIG. 3 illustrates a radio IC circuitry for use in the radio architecture of FIG. 1 in accordance with some embodiments.

FIG. 4 illustrates a baseband processing circuitry for use in the radio architecture of FIG. 1 in accordance with some embodiments.

FIG. 5 illustrates a WLAN in accordance with some embodiments.

FIG. 6 illustrates a block diagram of an example machine upon which any one or more of the techniques (e.g., methodologies) discussed herein may perform.

FIG. 7 illustrates a block diagram of an example wireless device upon which any one or more of the techniques (e.g., methodologies or operations) discussed herein may perform.

FIG. 8 illustrates broadcast TWT sharing, in accordance with some embodiments.

FIG. 9A illustrates a first mode of broadcast TWT sharing, in accordance with some embodiments.

FIG. 9B illustrates a second mode of broadcast TWT sharing, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In today's digital age, where connectivity is almost as essential as the air we breathe, managing power consumption in Wi-Fi networks has become a crucial challenge. This is particularly true for devices that rely on battery power, such as smartphones, laptops, and a growing array of Internet of Things 2 (IoT) devices. Efficient power management not only extends the battery life of these devices but also ensures smoother operation of the network as a whole.

One of the primary technologies used to manage power consumption in Wi-Fi networks involves the use of Target Wake Time (TWT). TWT is a scheduling mechanism that allows devices to determine specific times when they should wake up to send or receive data. This means that instead of a device constantly staying awake to check for possible communication from the access point (AP), it can sleep and only wake up at scheduled intervals. This scheduled wake-up reduces the energy used by the device, as it spends more time in a low-power state.

The described examples also discuss the concept of Power Save Mode, which is another method used to reduce power consumption. In this mode, devices intermittently wake up to listen for signals from the AP. If there are no data awaiting them, they can quickly return to a low-power state. This mode is less about scheduling and more about reducing the active time of a device when not needed, thereby conserving power.

Another component discussed is the Beacon Frame. This is a type of signal sent by the AP that helps synchronize devices connected to the network. It can carry information about TWT schedules, which informs devices of their next wake times. By using Beacon Frames effectively, an AP can manage multiple devices, ensuring they are awake only when necessary, thus optimizing the network's overall power usage.

Service Periods (SP) are also a crucial component. These are specific times set aside for data transmission between the AP and devices. By managing these periods effectively, the network can ensure that all communications are managed efficiently, with minimal power waste. Devices are active during these periods and return to a low-power state once their communication window closes.

The described examples also introduce a unique aspect of power management involving the Responder Power Management (PM) field. This field is used by the AP to indicate its power state—whether it is in an active state or a doze state outside of the scheduled service periods. This information is crucial for devices to understand the availability of the AP, allowing them to adjust their schedules accordingly.

In the described examples, a new field is proposed to be added to the TWT element, termed “Unavailability outside SP.” This field is set to indicate whether the AP (or the device) will be completely unavailable outside of the service periods defined by the TWT. If set to ‘1’, it means that the AP or device will not be available during these times, taking precedence over other rules. If set to ‘0’, it indicates availability, meaning the usual power save rules apply.

This field can be implemented in several ways. It might be added using a reserved field in the Control field of the TWT element, repurposing an existing field, or as part of a new line in the Broadcast TWT recommendation field. Alternatively, it could be included in an operational element of the AP to indicate that the unavailability rule applies to all TWT service periods where the Responder PM is set to ‘1’.

The value of these technologies to users and network operators lies in their ability to reduce power consumption without sacrificing connectivity. For individual users, this means longer battery life and less frequent charges. For network operators, particularly those managing large-scale or critical networks, it means more efficient use of resources and reduced operational costs.

Moreover, these technologies contribute to the sustainability goals of many organizations by reducing the energy footprint of their network operations. In an era where energy efficiency is increasingly under the spotlight, the ability to manage power intelligently in Wi-Fi networks is a significant advantage.

In summary, the technologies described in these examples provide a comprehensive approach to managing power in Wi-Fi networks. By using TWT for precise scheduling, Power Save Mode for reducing active time, and innovative fields like “Unavailability outside SP” for clear communication of availability, these technologies help optimize power usage, extend device battery life, and enhance network efficiency. This is crucial not only for user satisfaction but also for the broader goals of energy conservation and network management.

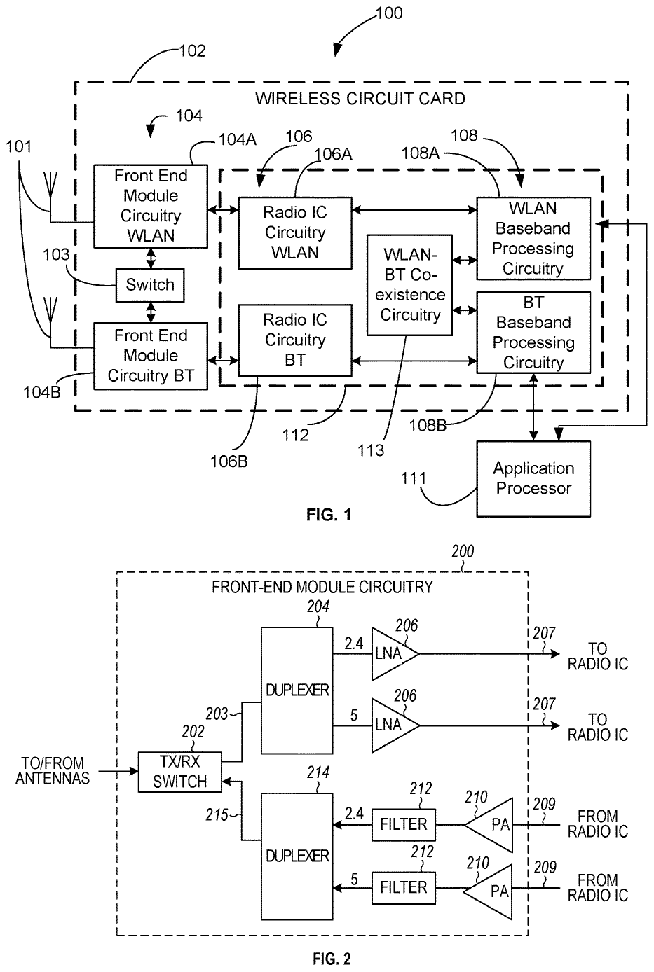

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM circuitry 104A and FEM circuitry 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry, and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM circuitry 104A or FEM circuitry 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, and/or IEEE 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80MHz (160 MHz) (with non-contiguous bandwidths). In some embodiments, a 320 MHz channel bandwidth may be used. The scope of the embodiments is not limited with respect to the above center frequencies however.

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

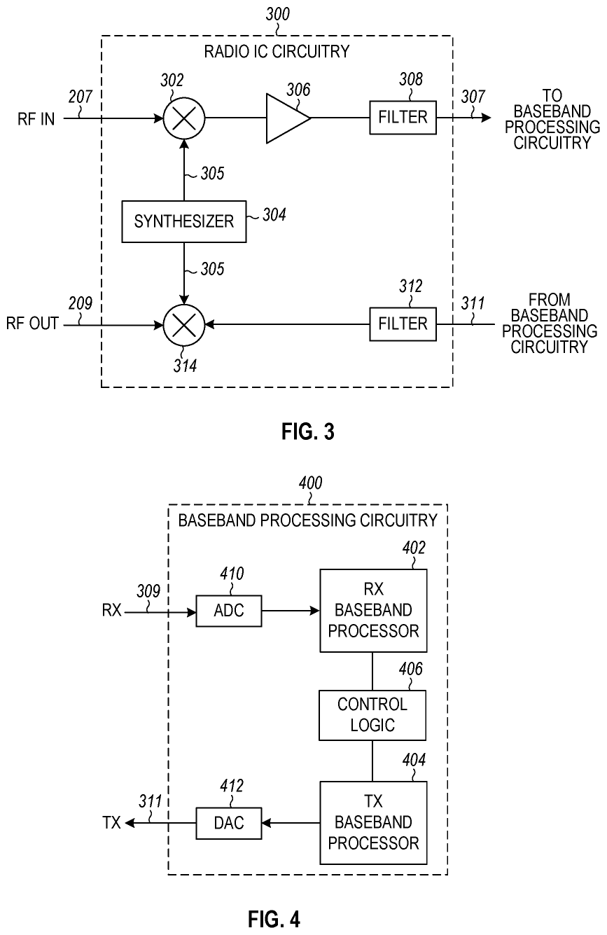

FIG. 3 illustrates radio integrated circuit (IC) circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 304 may be provided by a voltage controlled oscillator (VCO), although that is not a requirement. A divider control input may further be provided by either the baseband processing circuitry 108 (FIG. 1) or the application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processing circuitry 108A, the TX BBP 404 may be configured to generate OFDM or OFDMA signals as appropriate for transmission by performing an inverse fast Fourier transform (IFFT). The RX BBP 402 may be configured to process received OFDM signals or OFDMA signals by performing an FFT. In some embodiments, the RX BBP 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

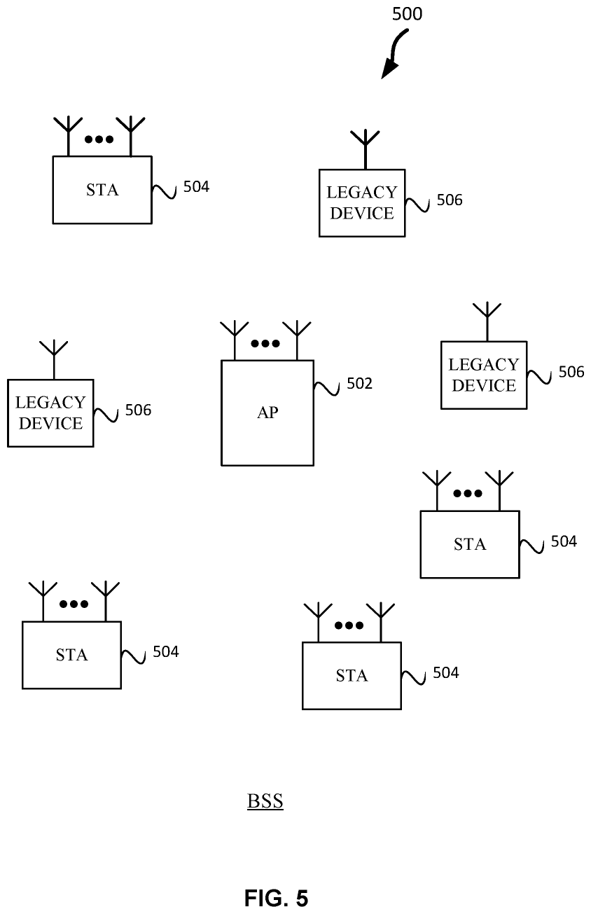

FIG. 5 illustrates a WLAN 500 in accordance with some embodiments. The WLAN 500 may comprise a basis service set (BSS) that may include an access point (AP) 502, a plurality of stations (STAs) 504, and a plurality of legacy devices 506. In some embodiments, the STAs 504 and/or AP 502 are configured to operate in accordance with IEEE 802.11be extremely high throughput (EHT) and/or high efficiency (HE) IEEE 802.11ax. In some embodiments, the STAs 504 and/or AP 520 are configured to operate in accordance with IEEE 802.11az. In some embodiments, IEEE 802.11EHT may be termed Next Generation 802.11 or a later standard. The STA 504 and AP 502 (or apparatuses of) may be configured to operate in accordance with IEEE P802.11be™/D2.2, October 2022, IEEE P802.11-REVme™/D2.0, October 2022, which are incorporated herein by reference in their entirety. The AP 502 and/or STA 504 may operate in accordance with different versions of the communication standards.

The AP 502 may be an AP using the IEEE 802.11 to transmit and receive. The AP 502 may be a base station. The AP 502 may use other communications protocols as well as the IEEE 802.11 protocol. The EHT protocol may be termed a different name in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one EHT AP that is part of an extended service set (ESS). A controller (not illustrated) may store information that is common to the more than one AP 502 and may control more than one BSS, e.g., assign primary channels and colors. AP 502 may be connected to the internet.

The legacy devices 506 may operate in accordance with one or more of IEEE 802.11a/b/g/n/ac/ad/af/ah/aj/ay/ax/be, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11be or another wireless protocol.

The AP 502 may communicate with legacy devices 506 in accordance with legacy IEEE 802.11 communication techniques. In example embodiments, the H AP 502 may also be configured to communicate with STAs 504 in accordance with legacy IEEE 802.11 communication techniques.

In some embodiments, a HE or EHT frames may be configurable to have the same bandwidth as a channel. The HE or EHT frame may be a physical Layer (PHY) Protocol Data Unit (PPDU). In some embodiments, PPDU may be an abbreviation for physical layer protocol data unit (PPDU). In some embodiments, there may be several types of PPDUs that may have different fields and different physical layers and/or different media access control (MAC) layers. For example, a single user (SU) PPDU, multiple-user (MU) PPDU, extended-range (ER) SU PPDU, and/or trigger-based (TB) PPDU. In some embodiments EHT may be the same or similar as HE PPDUs.

The bandwidth of a channel may be 20 MHz, 40 MHz, or 80 MHz, 80+80 MHz, 160 MHz, 160+160 MHz, 320 MHz, 320+320 MHz, 640 MHz bandwidths. In some embodiments, the bandwidth of a channel less than 20 MHz may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2x996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHZ OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats. In some embodiments, two or more of the RUs are joined as an MRU.

A HE or EHT frame may be configured for transmitting a number of spatial streams, which may be in accordance with MU-MIMO and may be in accordance with OFDMA. In other embodiments, the AP 502, STA 504, and/or legacy device 506 may also implement different technologies such as code division multiple access (CDMA) 2000, CDMA 2000 1X, CDMA 2000Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, low-power BlueTooth®, or other technologies.

In accordance with some IEEE 802.11 embodiments, e.g., IEEE 802.11EHT/ax embodiments, a HE AP may operate as a primary station which may be arranged to contend for a wireless medium (e.g., during a contention period) to receive exclusive control of the medium for a transmission opportunity (TXOP). The AP 502 may transmit an EHT/HE trigger frame transmission, which may include a schedule for simultaneous UL/DL transmissions from STAs 504. The AP 502 may transmit a time duration of the TXOP and sub-channel information. During the TXOP, STAs 504 may communicate with the AP 502 in accordance with a non-contention based multiple access technique such as OFDMA or MU-MIMO. This is unlike conventional WLAN communications in which devices communicate in accordance with a contention-based communication technique, rather than a multiple access technique. During the HE or EHT control period, the AP 502 may communicate with STAs 504 using one or more HE or EHT frames. During the TXOP, the HE STAs may operate on a sub-channel smaller than the operating range of the AP 502. During the TXOP, legacy stations refrain from communicating. The legacy stations may need to receive the communication from the HE AP to defer from communicating.

In accordance with some embodiments, during the TXOP the STAs 504 may contend for the wireless medium with the legacy devices 506 being excluded from contending for the wireless medium during the sync transmission. In some embodiments the trigger frame may indicate an UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE or EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or STAs 504 in accordance with legacy IEEE 802.11 communication techniques. In some embodiments, the AP 502 may also be configurable to communicate with STAs 504 outside the TXOP in accordance with legacy IEEE 802.11 or IEEE 802.11EHT/ax communication techniques, although this is not a requirement.

In some embodiments the STA 504 may be a “group owner” (GO) for peer-to-peer modes of operation. A wireless device may be a STA 504 or a HE AP.

In some embodiments, the STA 504 and/or AP 502 may be configured to operate in accordance with IEEE 802.11mc. In example embodiments, the radio architecture of FIG. 1 is configured to implement the STA 504 and/or the AP 502. In example embodiments, the front-end module circuitry of FIG. 2 is configured to implement the STA 504 and/or the AP 502. In example embodiments, the radio IC circuitry of FIG. 3 is configured to implement the STA 504 and/or the AP 502. In example embodiments, the base-band processing circuitry of FIG. 4 is configured to implement the STA 504 and/or the AP 502.

In example embodiments, the STAs 504, AP 502, an apparatus of the STA 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein described in conjunction with FIGS. 1-12.

In example embodiments, the STAs 504 and/or the HE AP are configured to perform the methods and operations/functions described herein in conjunction with FIGS. 1-12. In example embodiments, an apparatus of the STA 504 and/or an apparatus of the AP 502 are configured to perform the methods and functions described herein in conjunction with FIGS. 1-12. The term Wi-Fi may refer to one or more of the IEEE 802.11 communication standards. AP and STA may refer to EHT/HE access point and/or EHT/HE station as well as legacy devices 506.

In some embodiments, a HE AP STA may refer to an AP 502 and/or STAs 504 that are operating as EHT APs. In some embodiments, when a STA 504 is not operating as an AP, it may be referred to as a non-AP STA or non-AP. In some embodiments, STA 504 may be referred to as either an AP STA or a non-AP. In some embodiments, the AP 502 is an AP of the AP MLD. In some embodiments, the STA 504 is a STA of non-AP MLD 3 809.

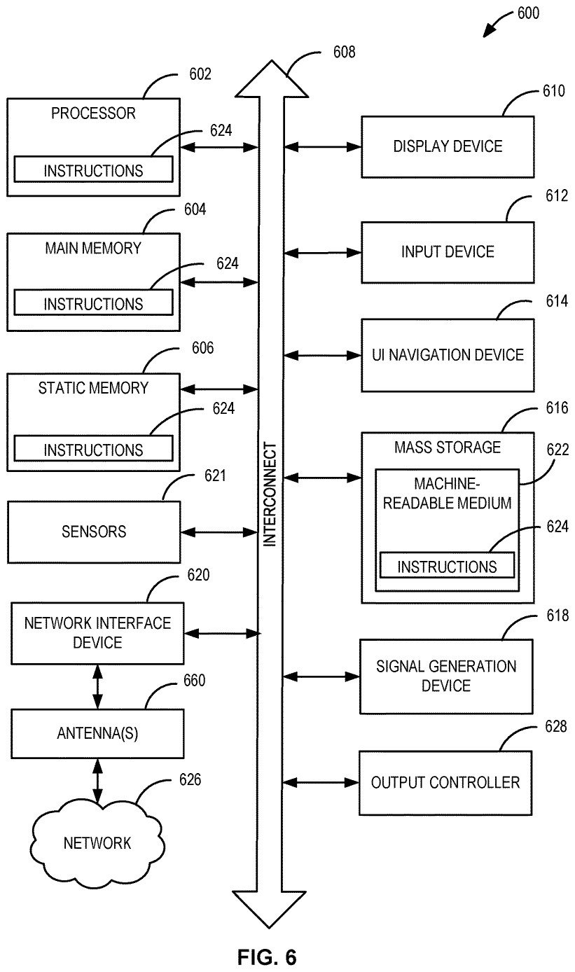

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may function as a peer machine in peer-to-peer (P2P) (or other distributed) network environment. The machine 600 may be a HE AP, EHT STA, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 600 may further include a display device 610, an input device 612 (e.g., a keyboard), and a user interface (UI) navigation device 614 (e.g., a mouse). In an example, the display device 610, input device 612 and UI navigation device 614 may be a touch screen display. The machine 600 may additionally include a mass storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared(IR), near field communication (NFC)). connection to communicate or control one or more peripheral devices (e.g., a printer, card reader). In some embodiments the processor 602 and/or instructions 624 may comprise processing circuitry and/or transceiver circuitry.

The mass storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the mass storage device 616 may constitute machine readable media.

Specific examples of machine readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 622 is illustrated as a single medium, the term “machine readable medium” may include a single medium or multiple media (e.g., a centralized or distributed database, and/or associated caches and servers) configured to store the one or more instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, sensors 621, network interface device 620, antennas 660, a display device 610, an input device 612, a UI navigation device 614, a mass storage device 616, instructions 624, a signal generation device 618, and an output controller 628. The apparatus may be configured to perform one or more of the methods and/or operations disclosed herein. The apparatus may be intended as a component of the machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP)). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at separate times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

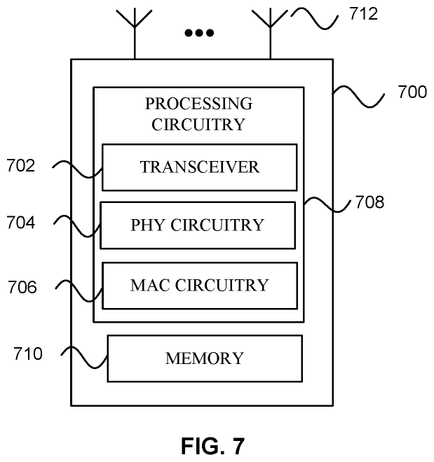

FIG. 7 illustrates a block diagram of an example wireless device 700 upon which any one or more of the techniques (e.g., methodologies or operations) discussed herein may perform. The wireless device 700 may be a HE device or HE wireless device. The wireless device 700 may be a HE STA, HE AP, and/or a HE STA or HE AP. A HE STA, HE AP, and/or a HE AP or HE STA may include some or all of the components shown in FIGS. 1-7. The wireless device 700 may be an example machine 600 as disclosed in conjunction with FIG. 6.

The wireless device 700 may include processing circuitry 708. The processing circuitry 708 may include a transceiver 702, physical layer circuitry (PHY circuitry) 704, and MAC layer circuitry (MAC circuitry) 706, one or more of which may enable transmission and reception of signals to and from other wireless devices 700 (e.g., HE AP, HE STA, and/or legacy devices 506) using one or more antennas 712. As an example, the PHY circuitry 704 may perform various encoding and decoding functions that may include formation of baseband signals for transmission and decoding of received signals. As another example, the transceiver 702 may perform various transmission and reception functions such as conversion of signals between a baseband range and a Radio Frequency (RF) range.

Accordingly, the PHY circuitry 704 and the transceiver 702 may be separate components or may be part of a combined component, e.g., processing circuitry 708. In addition, some of the described functionality related to transmission and reception of signals may be performed by a combination that may include one, any or all of the PHY circuitry 704 the transceiver 702, MAC circuitry 706, memory 710, and other components or layers. The MAC circuitry 706 may control access to the wireless medium. The wireless device 700 may also include memory 710 arranged to perform the operations described herein, e.g., some of the operations described herein may be performed by instructions stored in the memory 710.

The antennas 712 (some embodiments may include only one antenna) may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 712 may be effectively separated to take advantage of spatial diversity and the different channel characteristics that may result.

One or more of the memory 710, the transceiver 702, the PHY circuitry 704, the MAC circuitry 706, the antennas 712, and/or the processing circuitry 708 may be coupled with one another. Moreover, although memory 710, the transceiver 702, the PHY circuitry 704, the MAC circuitry 706, the antennas 712 are illustrated as separate components, one or more of memory 710, the transceiver 702, the PHY circuitry 704, the MAC circuitry 706, the antennas 712 may be integrated in an electronic package or chip.

In some embodiments, the wireless device 700 may be a mobile device as described in conjunction with FIG. 6. In some embodiments the wireless device 700 may be configured to operate in accordance with one or more wireless communication standards as described herein (e.g., as described in conjunction with FIGS. 1-6, IEEE 802.11). In some embodiments, the wireless device 700 may include one or more of the components as described in conjunction with FIG. 6 (e.g., display device 610 or input device 612). Although the wireless device 700 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In some embodiments, an apparatus of or used by the wireless device 700 may include various components of the wireless device 700 as shown in FIG. 7 and/or components from FIGS. 1-6. Accordingly, techniques and operations described herein that refer to the wireless device 700 may be applicable to an apparatus for a wireless device 700 (e.g., HE AP and/or HE STA), in some embodiments. In some embodiments, the wireless device 700 is configured to decode and/or encode signals, packets, and/or frames as described herein, e.g., PPDUs.

In some embodiments, the MAC circuitry 706 may be arranged to contend for a wireless medium during a contention period to receive control of the medium for a HE TXOP and encode or decode an HE PPDU. In some embodiments, the MAC circuitry 706 may be arranged to contend for the wireless medium based on channel contention settings, a transmitting power level, and a clear channel assessment level (e.g., an energy detect level).

The PHY circuitry 704 may be arranged to transmit signals in accordance with one or more communication standards described herein. For example, the PHY circuitry 704 may be configured to transmit a HE PPDU. The PHY circuitry 704 may include circuitry for modulation/demodulation, upconversion/downconversion, filtering and amplification. In some embodiments, the processing circuitry 708 may include one or more processors. The processing circuitry 708 may be configured to perform functions based on instructions being stored in a RAM or ROM, or based on special purpose circuitry. The processing circuitry 708 may include a processor such as a general purpose processor or special purpose processor. The processing circuitry 708 may implement one or more functions associated with antennas 712, the transceiver 702, the PHY circuitry 704, the MAC circuitry 706, and/or the memory 710. In some embodiments, the processing circuitry 708 may be configured to perform one or more of the functions/operations and/or methods described herein.

In mm Wave technology, communication between a station (e.g., the HE STA of FIG. 5 or wireless device 700) and an access point (e.g., the HE AP of FIG. 5 or wireless device 700) may use associated effective wireless channels that are highly directionally dependent. To accommodate the directionality, beamforming techniques may be utilized to radiate energy in a certain direction with certain beamwidth to communicate between two devices. The directed propagation concentrates transmitted energy toward a target device in order to compensate for significant energy loss in the channel between the two communicating devices. Using directed transmission may extend the range of the millimeter-wave communication versus utilizing the same transmitted energy in omni-directional propagation.

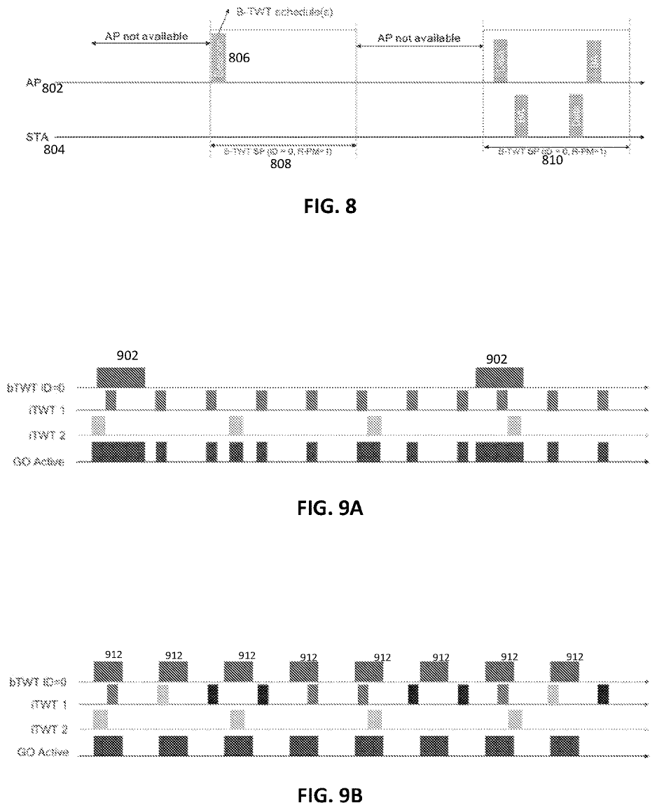

FIG. 8 illustrates broadcast TWT sharing, in accordance with some embodiments. In FIG. 8, an AP 802 operating as a Target Wake-up Time (TWT) scheduling AP and may encode a broadcast TWT element for transmission in a beacon frame 806. In these embodiments, the broadcast TWT element may advertise a broadcast TWT with one or more broadcast TWT Service Periods (SPs) 808, 810. The broadcast TWT element may carry one or more broadcast TWT parameter set fields with a broadcast TWT ID subfield equal to zero and has a Responder Power Management (PM) Mode subfield equal to one (B-TWT SP (ID=0, R-PM=1). The AP may be is unavailable outside of the one or more broadcast TWT SPs 808, 810. During the one or more broadcast TWT SPs 808, the AP may allow non-AP stations (STAs) 804 that are members of a BSS of the AP to discover, probe and associate with the AP when they are not associated, and once associated, allow the STAs to negotiate other service periods in order to operate with the AP by negotiating [Individual or Broadcast] TWTs with the AP. During the one or more broadcast TWT SPs 810, the AP may be available communicate with the non-AP STAs 804

FIG. 9A illustrates a first mode of broadcast TWT sharing, in accordance with some embodiments. In these embodiments, when the broadcast TWT element carries one or more broadcast TWT parameter set fields with a broadcast TWT ID subfield equal to zero and has a Responder Power Management (PM) Mode subfield equal to one, the AP may set a NDP Paging Indicator/Unavailability Mode subfield of a Control Field to a value of zero to indicate that the AP is unavailable outside of the one or more broadcast TWT SPs except for other TWT SPs that are setup with the AP or advertised by the AP. As illustrated in FIG. 9A, the AP is available (i.e., GO Active) during the broadcast TWT SPs 902, and is also available outside the broadcast TWT SPs 902 during the other TWT SPs that are setup with the AP or advertised by the AP (i.e., iTWT 1 and iTWT 2).

FIG. 9B illustrates a second mode of broadcast TWT sharing, in accordance with some embodiments. In these embodiments, when the broadcast TWT element carries one or more broadcast TWT parameter set fields with a broadcast TWT ID subfield equal to zero and has a Responder Power Management (PM) Mode subfield equal to one, the AP may set the NDP Paging Indicator/Unavailability Mode subfield of the Control field to a value of one to indicate that the AP is unavailable outside of the one or more broadcast TWT SPs including unavailable during any time that falls within the other TWT SPs that are setup with the AP or advertised by the AP. As illustrated in FIG. 9B, the AP is available (i.e., GO Active) during the broadcast TWT SPs 912, and is not available outside the broadcast TWT SPs 912 during the other TWT SPs that are setup with the AP or advertised by the AP (i.e., iTWT 1 and iTWT 2).

Embodiments described herein pertain to the management of power consumption in wireless local area networks (WLANs) through the use of a scheduling mechanism known as Target Wake Time (TWT) and a Power Save Mode. These mechanisms are implemented to enhance the efficiency of power usage across devices connected to the network, such as access points (APs) and non-access point stations (STAs).

In some examples, an access point (AP) is equipped with processing circuitry and memory. The processing circuitry is configured to encode a broadcast TWT element for transmission. This broadcast TWT element advertises a broadcast TWT with one or more broadcast TWT Service Periods (SPs). The broadcast TWT element includes a Control field, which plays a crucial role in indicating the availability of the AP outside these service periods.

The Control field may incorporate a NDP Paging Indicator/Unavailability Mode subfield. This subfield is set to a value of zero or one. When set to zero, it indicates that the AP is unavailable outside of the one or more broadcast TWT SPs except for other TWT SPs that are set up with the AP or advertised by the AP. Conversely, when set to one, it indicates that the AP is completely unavailable outside of the one or more broadcast TWT SPs, including during any time that falls within other TWT SPs that are set up with the AP or advertised by the AP.

In some examples, the processing circuitry of the AP is further configured to set the Responder PM Mode subfield to a value of one. This setting indicates that the AP will be in a doze state outside of the one or more broadcast TWT SPs. This configuration is helpful for reducing power consumption when the AP is not actively engaged in data transmission.

Additionally, the AP may encode the broadcast TWT element for transmission in a Beacon frame that is scheduled at a Target Beacon Transmission Time (TBTT). This scheduling ensures that the broadcast TWT element is transmitted at optimal times to maintain network synchronization and efficiency.

In some examples, during the one or more broadcast TWT SPs, the processing circuitry of the AP allows non-AP stations (STAs) that are members of a Basic Service Set (BSS) of the AP to discover, probe, and associate with the AP when they are not associated. Once associated, these STAs may negotiate other service periods to operate with the AP by negotiating individual or broadcast TWTs with the AP.

Furthermore, the described technology may include a computer-readable storage medium that stores instructions for execution by the processing circuitry of an AP. These instructions enable the AP to perform the aforementioned configurations and settings, thereby facilitating efficient power management in WLANs.

In some examples, a non-access point station (STA) includes processing circuitry and memory configured to decode a broadcast TWT element received from an AP. The STA's processing circuitry determines if the NDP Paging Indicator/Unavailability Mode subfield of the Control Field is set to a value of zero or one, and configures its operations accordingly. This allows the STA to manage its power consumption effectively by aligning its active periods with those of the AP, based on the broadcast TWT schedules.

These technical details illustrate a comprehensive approach to managing power consumption in WLANs through the use of TWT scheduling and Power Save Mode, enhancing network efficiency and device battery life.

Some embodiments are directed to access point (AP) configured for operation in a wireless local area network (WLAN). In these embodiments, when the AP is operating as a Target Wake-up Time (TWT) scheduling AP, the AP may encode a broadcast TWT element for transmission, the broadcast TWT element to advertise a broadcast TWT with one or more broadcast TWT Service Periods (SPs). The broadcast TWT element may include a Control field. When the broadcast TWT element carries one or more broadcast TWT parameter set fields with a broadcast TWT ID subfield equal to zero and has a Responder Power Management (PM) Mode subfield equal to one, the AP may set a NDP Paging Indicator/Unavailability Mode subfield of the Control Field to a value of zero to indicate that the AP is unavailable outside of the one or more broadcast TWT SPs except for other TWT SPs that are setup with the AP or advertised by the AP. The AP may set the NDP Paging Indicator/Unavailability Mode subfield of the Control field to a value of one to indicate that the AP is unavailable outside of the one or more broadcast TWT SPs including unavailable during any time that falls within the other TWT SPs that are setup with the AP or advertised by the AP.

In these embodiments, the AP sets the NDP Paging Indicator/Unavailability Mode subfield of the Control Field to a value of zero, the AP is unavailable outside of the one or more broadcast TWT SPs except that the AP is available during TWT SPs set up or advertised by the AP that are outside the one or more broadcast TWT SPs if any such TWT SPs exist. In these embodiments, the AP sets the NDP Paging Indicator/Unavailability Mode subfield of the Control field to a value of one to indicate that the AP is unavailable outside of the one or more broadcast TWT SPs and unavailable during TWT SPs that are set up or advertised by the AP that are outside the one or more broadcast TWT SPs if any such TWT SPs exist.

In some embodiments, the AP may set the Responder PM Mode subfield to a value of one to indicate that the AP will be in a doze state outside of the one or more broadcast TWT SPs.

In some embodiments, when the NDP Paging Indicator/Unavailability Mode subfield is set to a value of one, the AP is unavailable outside of the one or more broadcast TWT SPs and is not capable of receiving PPDUs.

In some embodiments, the AP may encode the broadcast TWT element for transmission by the AP in a Beacon frame that is scheduled at a Target Beacon Transmission Time (TBTT),
wherein when the broadcast TWT element is encoded to have a TWT ID set to a value of zero and encoded to have the Responder PM Mode subfield set to the value of one, the processing circuitry configures the AP to remain active during the one or more broadcast TWT SPs indicated by a beacon TWT schedule in the Beacon frame. An example of this is illustrated in FIG. 8 (i.e., BCST TWT SP ID0 RPM1).

In some embodiments, during the one or more broadcast TWT SPs, the processing circuitry is configured to allow non-AP stations (STAs) that are members of a BSS of the AP to discover, probe and associate with the AP when they are not associated, and once associated, allow the STAs to negotiate other service periods in order to operate with the AP by negotiating Individual or Broadcast TWTs with the AP.

In some embodiments, when the NDP Paging Indicator/Unavailability Mode subfield is set to the value of zero and the Responder Mode subfield is equal to one, the processing circuitry configures the AP to be available within negotiated Individual or Broadcast TWTs that are outside the one or more broadcast TWT SPs, and
wherein when the NDP Paging Indicator/Unavailability Mode subfield is set to the value of one and the Responder Mode subfield is equal to one, the processing circuitry configured the AP to be unavailable outside the one or more broadcast TWT SPs including unavailable during the negotiated Individual or Broadcast TWTs.

In some embodiments, when the NDP Paging Indicator/Unavailability Mode subfield is set to the value of zero and the Responder Mode subfield is equal to one, the processing circuitry is to configure the AP to encode frames for transmission during the other TWT SPs that are setup with the AP or advertised by the AP that is outside of the one or more broadcast TWT SPs, and
when the NDP Paging Indicator/Unavailability Mode subfield is set to the value of one and the Responder Mode subfield is equal to one, the processing circuitry is to configure the AP to refrain from encoding frames for transmission during the other TWT SPs that are setup with the AP or advertised by the AP that is outside of the one or more broadcast TWT SPs.

In some embodiments, when the NDP Paging Indicator/Unavailability Mode subfield is set to the value of zero and the Responder Mode subfield is equal to one, the processing circuitry is to configure the AP to decode frames received during the other TWT SPs that are setup with the AP or advertised by the AP that is outside of the one or more broadcast TWT SPs, and
when the NDP Paging Indicator/Unavailability Mode subfield is set to the value of one and the Responder Mode subfield is equal to one, the processing circuitry is to configure the AP to refrain from decoding frames during the other TWT SPs that are setup with the AP or advertised by the AP that is outside of the one or more broadcast TWT SPs.

Some embodiments are directed to a computer-readable storage medium that stores instructions for execution by processing circuitry of an apparatus of an access point (AP) configured for operation in a wireless local area network (WLAN). In these embodiments, when the AP is operating as a Target Wake-up Time (TWT) scheduling AP, the processing circuitry may encode a broadcast TWT element for transmission. In these embodiments, the broadcast TWT element may advertise a broadcast TWT with one or more broadcast TWT Service Periods (SPs). In these embodiments, when the broadcast TWT element carries one or more broadcast TWT parameter set fields with a broadcast TWT ID subfield equal to zero and has a Responder Power Management (PM) Mode subfield equal to one, the processing circuitry may set a NDP Paging Indicator/Unavailability Mode subfield of the Control Field to a value of zero to indicate that the AP is unavailable outside of the one or more broadcast TWT SPs except for other TWT SPs that are setup with the AP or advertised by the AP. In these embodiments, when the broadcast TWT element carries one or more broadcast TWT parameter set fields with a broadcast TWT ID subfield equal to zero and has a Responder Power Management (PM) Mode subfield equal to one, the processing circuitry may set the NDP Paging Indicator/Unavailability Mode subfield of the Control field to a value of one to indicate that the AP is unavailable outside of the one or more broadcast TWT SPs including unavailable during any time that falls within the other TWT SPs that are setup with the AP or advertised by the AP.

Some embodiments are directed to a non-access point station (STA) configured for operation in a wireless local area network (WLAN). In these embodiments, the STA may decode a broadcast TWT element received from an access point (AP) operating as a Target Wake-up Time (TWT) scheduling AP, the broadcast TWT element advertising a broadcast TWT with one or more broadcast TWT Service Periods (SPs), the broadcast TWT element including a Control field. When the broadcast TWT element carries one or more broadcast TWT parameter set fields with a broadcast TWT ID subfield equal to zero and has a Responder Power Management (PM) Mode subfield equal to one, the STA may determine if a NDP Paging Indicator/Unavailability Mode subfield of the Control Field is set to a value of zero or a value of one. In these embodiments, when the NDP Paging Indicator/Unavailability Mode subfield of the Control Field is set to the value of zero, the AP is unavailable outside of the one or more broadcast TWT SPs except for other TWT SPs that are setup with the AP or advertised by the AP. In these embodiments, when the NDP Paging Indicator/Unavailability Mode subfield of the Control field is set to the value of one, the AP is unavailable outside of the one or more broadcast TWT SPs including unavailable during any time that falls within the other TWT SPs that are setup with the AP or advertised by the AP.

In these embodiments, when the NDP Paging Indicator/Unavailability Mode subfield is set to the value of zero and the Responder Mode subfield is equal to one, the STA may encode frames for transmission to the AP during the other TWT SPs that are setup with the AP or advertised by the AP that are outside of the one or more broadcast TWT SPs. When the NDP Paging Indicator/Unavailability Mode subfield is set to the value of one and the Responder Mode subfield is equal to one, the STA may refrain from encoding frames for transmission to the AP during the other TWT SPs that are setup with the AP or advertised by the AP that are outside of the one or more broadcast TWT SPs. In these embodiments, the STA may receive the broadcast TWT element from the AP in a Beacon frame that is scheduled at a Target Beacon Transmission Time (TBTT).

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access point (AP) configured for operation in a wireless local area network (WLAN), the apparatus comprising: processing circuitry; and memory,
wherein when the AP is operating as a Target Wake-up Time (TWT) scheduling AP, the processing circuitry configured to:
encode a broadcast TWT element for transmission, the broadcast TWT element to advertise a broadcast TWT with one or more broadcast TWT Service Periods (SPs), the broadcast TWT element including a Control field,
wherein when the broadcast TWT element carries one or more broadcast TWT parameter set fields with a broadcast TWT ID subfield equal to zero and has a Responder Power Management (PM) Mode subfield equal to one, the processing circuitry is configured to:
set a NDP Paging Indicator/Unavailability Mode subfield of the Control Field to a value of zero to indicate that the AP is unavailable outside of the one or more broadcast TWT SPs except for other TWT SPs that are setup with the AP or advertised by the AP; and
set the NDP Paging Indicator/Unavailability Mode subfield of the Control field to a value of one to indicate that the AP is unavailable outside of the one or more broadcast TWT SPs including unavailable during any time that falls within the other TWT SPs that are setup with the AP or advertised by the AP.

2. The apparatus of claim 1, wherein the processing circuitry is configured to set the Responder PM Mode subfield to a value of one to indicate that the AP will be in a doze state outside of the one or more broadcast TWT SPs.

3. The apparatus of claim 2, wherein when the NDP Paging Indicator/Unavailability Mode subfield is set to a value of one, the AP is unavailable outside of the one or more broadcast TWT SPs and is not capable of receiving PPDUs.

4. The apparatus of claim 3, wherein the processing circuitry is configured to encode the broadcast TWT element for transmission by the AP in a Beacon frame that is scheduled at a Target Beacon Transmission Time (TBTT),
wherein when the broadcast TWT element is encoded to have a TWT ID set to a value of zero and encoded to have the Responder PM Mode subfield set to the value of one, the processing circuitry configures the AP to remain active during the one or more broadcast TWT SPs indicated by a beacon TWT schedule in the Beacon frame.

5. The apparatus of claim 4, wherein during the one or more broadcast TWT SPs, the processing circuitry is configured to allow non-AP stations (STAs) that are members of a BSS of the AP to discover, probe and associate with the AP when they are not associated, and once associated, allow the STAs to negotiate other service periods in order to operate with the AP by negotiating TWTs with the AP.

6. The apparatus of claim 4, wherein when the NDP Paging Indicator/Unavailability Mode subfield is set to the value of zero and the Responder Mode subfield is equal to one, the processing circuitry configures the AP to be available within negotiated TWTs that are outside the one or more broadcast TWT SPs, and
wherein when the NDP Paging Indicator/Unavailability Mode subfield is set to the value of one and the Responder Mode subfield is equal to one, the processing circuitry configured the AP to be unavailable outside the one or more broadcast TWT SPs including unavailable during the negotiated TWTs.

7. The apparatus of claim 4, wherein when the NDP Paging Indicator/Unavailability Mode subfield is set to the value of zero and the Responder Mode subfield is equal to one, the processing circuitry is to configure the AP to encode frames for transmission during the other TWT SPs that are setup with the AP or advertised by the AP that is outside of the one or more broadcast TWT SPs, and
when the NDP Paging Indicator/Unavailability Mode subfield is set to the value of one and the Responder Mode subfield is equal to one, the processing circuitry is to configure the AP to refrain from encoding frames for transmission during the other TWT SPs that are setup with the AP or advertised by the AP that is outside of the one or more broadcast TWT SPs.

8. The apparatus of claim 4, wherein when the NDP Paging Indicator/Unavailability Mode subfield is set to the value of zero and the Responder Mode subfield is equal to one, the processing circuitry is to configure the AP to decode frames received during the other TWT SPs that are setup with the AP or advertised by the AP that is outside of the one or more broadcast TWT SPs, and
when the NDP Paging Indicator/Unavailability Mode subfield is set to the value of one and the Responder Mode subfield is equal to one, the processing circuitry is to configure the AP to refrain from decoding frames during the other TWT SPs that are setup with the AP or advertised by the AP that is outside of the one or more broadcast TWT SPs.

9. A computer-readable storage medium that stores instructions for execution by processing circuitry of an apparatus of an access point (AP) configured for operation in a wireless local area network (WLAN), wherein when the AP is operating as a Target Wake-up Time (TWT) scheduling AP, the processing circuitry configured to:
encode a broadcast TWT element for transmission, the broadcast TWT element to advertise a broadcast TWT with one or more broadcast TWT Service Periods (SPs), the broadcast TWT element including a Control field,
wherein when the broadcast TWT element carries one or more broadcast TWT parameter set fields with a broadcast TWT ID subfield equal to zero and has a Responder Power Management (PM) Mode subfield equal to one, the processing circuitry is configured to:
set a NDP Paging Indicator/Unavailability Mode subfield of the Control Field to a value of zero to indicate that the AP is unavailable outside of the one or more broadcast TWT SPs except for other TWT SPs that are setup with the AP or advertised by the AP; and
set the NDP Paging Indicator/Unavailability Mode subfield of the Control field to a value of one to indicate that the AP is unavailable outside of the one or more broadcast TWT SPs including unavailable during any time that falls within the other TWT SPs that are setup with the AP or advertised by the AP.

10. The computer-readable storage medium of claim 9, wherein the processing circuitry is configured to set the Responder PM Mode subfield to a value of one to indicate that the AP will be in a doze state outside of the one or more broadcast TWT SPs.

11. The computer-readable storage medium of claim 10, wherein when the NDP Paging Indicator/Unavailability Mode subfield is set to a value of one, the AP is unavailable outside of the one or more broadcast TWT SPs and is not capable of receiving PPDUs.

12. The computer-readable storage medium of claim 11, wherein the processing circuitry is configured to encode the broadcast TWT element for transmission by the AP in a Beacon frame that is scheduled at a Target Beacon Transmission Time (TBTT),
wherein when the broadcast TWT element is encoded to have a TWT ID set to a value of zero and encoded to have the Responder PM Mode subfield set to the value of one, the processing circuitry configures the AP to remain active during the one or more broadcast TWT SPs indicated by a beacon TWT schedule in the Beacon frame.

13. The computer-readable storage medium of claim 12, wherein during the one or more broadcast TWT SPs, the processing circuitry is configured to allow non-AP stations (STAs) that are members of a BSS of the AP to discover, probe and associate with the AP when they are not associated, and once associated, allow the STAs to negotiate other service periods in order to operate with the AP by negotiating TWTs with the AP.

14. The computer-readable storage medium of claim 12, wherein when the NDP Paging Indicator/Unavailability Mode subfield is set to the value of zero and the Responder Mode subfield is equal to one, the processing circuitry configures the AP to be available within negotiated TWTs that are outside the one or more broadcast TWT SPs, and
wherein when the NDP Paging Indicator/Unavailability Mode subfield is set to the value of one and the Responder Mode subfield is equal to one, the processing circuitry configured the AP to be unavailable outside the one or more broadcast TWT SPs including unavailable during the negotiated TWTs.

15. The computer-readable storage medium of claim 12, wherein when the NDP Paging Indicator/Unavailability Mode subfield is set to the value of zero and the Responder Mode subfield is equal to one, the processing circuitry is to configure the AP to encode frames for transmission during the other TWT SPs that are setup with the AP or advertised by the AP that is outside of the one or more broadcast TWT SPs, and
when the NDP Paging Indicator/Unavailability Mode subfield is set to the value of one and the Responder Mode subfield is equal to one, the processing circuitry is to configure the AP to refrain from encoding frames for transmission during the other TWT SPs that are setup with the AP or advertised by the AP that is outside of the one or more broadcast TWT SPs.

16. The computer-readable storage medium of claim 12, wherein when the NDP Paging Indicator/Unavailability Mode subfield is set to the value of zero and the Responder Mode subfield is equal to one, the processing circuitry is to configure the AP to decode frames received during the other TWT SPs that are setup with the AP or advertised by the AP that is outside of the one or more broadcast TWT SPs, and
when the NDP Paging Indicator/Unavailability Mode subfield is set to the value of one and the Responder Mode subfield is equal to one, the processing circuitry is to configure the AP to refrain from decoding frames during the other TWT SPs that are setup with the AP or advertised by the AP that is outside of the one or more broadcast TWT SPs.

17. An apparatus of a non-access point station (STA) configured for operation in a wireless local area network (WLAN), the apparatus comprising:
processing circuitry; and memory,
the processing circuitry configured to:
decode a broadcast TWT element received from an access point (AP) operating as a Target Wake-up Time (TWT) scheduling AP, the broadcast TWT element advertising a broadcast TWT with one or more broadcast TWT Service Periods (SPs), the broadcast TWT element including a Control field,
wherein when the broadcast TWT element carries one or more broadcast TWT parameter set fields with a broadcast TWT ID subfield equal to zero and has a Responder Power Management (PM) Mode subfield equal to one, the processing circuitry is configured to:
determine if a NDP Paging Indicator/Unavailability Mode subfield of the Control Field is set to a value of zero or a value of one;
wherein when the NDP Paging Indicator/Unavailability Mode subfield of the Control Field is set to the value of zero, the AP is unavailable outside of the one or more broadcast TWT SPs except for other TWT SPs that are setup with the AP or advertised by the AP; and
wherein when the NDP Paging Indicator/Unavailability Mode subfield of the Control field is set to the value of one, the AP is unavailable outside of the one or more broadcast TWT SPs including unavailable during any time that falls within the other TWT SPs that are setup with the AP or advertised by the AP.

18. The apparatus of claim 17, wherein when the NDP Paging Indicator/Unavailability Mode subfield is set to the value of zero and the Responder Mode subfield is equal to one, the processing circuitry is to configure the STA to encode frames for transmission to the AP during the other TWT SPs that are setup with the AP or advertised by the AP that are outside of the one or more broadcast TWT SPs.

19. The apparatus of claim 18, wherein when the NDP Paging Indicator/Unavailability Mode subfield is set to the value of one and the Responder Mode subfield is equal to one, the processing circuitry is to configure the STA to refrain from encoding frames for transmission to the AP during the other TWT SPs that are setup with the AP or advertised by the AP that are outside of the one or more broadcast TWT SPs.

20. The apparatus of claim 19, wherein the processing circuitry is to configure the STA to receive the broadcast TWT element from the AP in a Beacon frame that is scheduled at a Target Beacon Transmission Time (TBTT).
